(19) United States
(12) Patent Application Publication
(10) Pub. No.: US 2019/0291860 A1
(43) Pub. Date: Sep. 26, 2019

(54) VERTICAL TAKE-OFF AND LANDING AIRCRAFT AND CONTROL METHOD

(71) Applicant: MONO AEROSPACE IP LTD, London (GB)

(72) Inventor: Brian Morgan, London (GB)

(73) Assignee: MONO AEROSPACE IP LTD, London (GB)

(21) Appl. No.: 16/345,236

(22) PCT Filed: Oct. 27, 2017
(86) PCT No.: PCT/GB2017/053249

§ 371 Date: Apr. 25, 2019

(30) Foreign Application Priority Data
Oct. 27, 2016 (GB) 1618197.6

(51) Int. Cl. B64C 27/30; B64C 27/20; B64C 27/26; B64C 29/00

(52) U.S. Cl. CPC B64C 27/30; B64C 27/20; B64C 27/26; B64C 2201/165; B64C 2201/021; B64C 2201/108; B64C 29/0025

(57) ABSTRACT

A vertical take-off and landing aircraft, and a control method for the aircraft, are disclosed. The aircraft has a vertical motion mode and a forward thrust mode. The aircraft comprises an airframe, having a wing section; a forward thrust means, for use during the forward thrust mode; a vertical lift rotor system, the rotor system being housed in a portion of the airframe; and a rotor control component configured to, during forward thrust, actuate the rotor system to modify the aerodynamic flow around the portion of the airframe housing the rotor system. Forward thrust may occur during the forward thrust mode, or other flight modes, such as transition phases to/from vertical motion and forward thrust modes. Modification of the aerodynamic flow may be used to optimize the aerodynamic flow around the portion of the airframe housing the rotor system.

### FIELD OF THE INVENTION

This invention is directed to vertical take-off and landing aircraft, and control methods for such aircraft. Embodiments of the invention relate generally to specially designed fixed-wing aircraft configurations and more specifically to specialized vertical take-off and landing (VTOL) aircraft designs.

### BACKGROUND TO THE INVENTION

There are many different types of VTOL aircraft designs. One well known method for accomplishing VTOL flight is via tilt-rotor designs where typically two (or more) larger propellers or rotors are mounted on pivoting axles at the ends of wingspans on these aircraft, and they then tilt or pivot from vertical orientation for lift off, to horizontal orientations as they transition through and enter normal forward flight mode. One of the major downfalls of this design is the dangerous time while the rotors are slowly tilting toward forward flight orientation. As the rotors tilt, their overall vertical lift force that was supporting the aircraft's weight is quickly reduced while the wings do not yet have sufficient lift force generated yet during the relatively slow transition to the forward flight speed needed. In these moments small anomalies, changes in wind speed or direction can stall the rotor(s), which is a possibly aircraft fatal condition for just a two-rotor equipped machine.

Another method of VTOL execution used on other designs is called redirected thrust augmentation. This is technically the same as a tilt rotor concept concerning the physics of what's going on to balance the airframes in each case, but these aircraft are typically powered by turbofan or turbojet engines producing tremendous amounts of thrust instead of larger exposed rotor systems. The raw thrust is directed downward for vertical take-off and hovering and then “redirected” (tilted) rearward to drive the plane into forward flight. The same type of danger exists for redirected thrust type designs as they tilt thrust away from supporting the aircraft, but this concern is sometimes reduced due to the typically huge horsepower to weight ratio differences of these airframes. The Harrier fighter jet (British military's AV8 Harrier) is probably the best example of this type of VTOL design. There are other previously considered methods and systems which describe similar airframe designs having horizontal and vertical flight, take-off and landing function.

One such previously considered system described in U.S. Pat. No. 6,843,447 depicts a fixed wing airframe but with rotors systems only enclosed in larger inner wings that are immediately adjacent to a strictly centre mass type fuselage, and aft-wing mounted thrusters. U.S. Pat. No. 5,890,441 describes an unmanned aerial vehicle of both vertical and horizontal flight characteristics, but employing two main fuselage-mounted and equally-spaced rotor systems surrounding the typical centre of gravity of their design.

In addition, previously considered systems have often not found satisfactory solutions to the problems of drag introduced by the incorporation of rotors into wing sections. Moreover, various features of an airframe may increase drag in such arrangements.

The present invention aims to address these problems and provide improvements upon the known devices and methods.

### SUMMARY OF THE INVENTION

Aspects and embodiments of the invention are set out in the accompanying claims.

In general terms, one embodiment of a first aspect of the invention can provide a vertical take-off and landing aircraft, having a vertical motion mode and a forward thrust mode, the aircraft comprising: an airframe, comprising a wing section; a forward thrust means, for use during the forward thrust mode; a vertical lift rotor system, the rotor system being housed in a portion of the airframe; and a rotor control component configured to, during forward thrust, actuate the rotor system to modify the aerodynamic flow around the portion of the airframe housing the rotor system.

This modification of the air flow during forward thrust allows the aircraft to significantly reduce drag. In particular, the presence of the rotor system in the airframe, in comparison to a standard winged aircraft, may otherwise be expected to produce more drag; embodiments of the invention can therefore mitigate or ameliorate this effect. The use of the rotor system in this way to influence, morph, moderate or shape the aerodynamic flow over the airframe effectively acts to move the aerodynamic centre of that portion of the airframe during the forward thrust mode. The actuation of the rotor system during forward thrust may be during the forward thrust mode itself, or during a transition to/from the vertical motion and forward thrust modes.

The wing section may be a wing member or arrangement (such as an assembly of components); the thrust means may simple be a thruster; and the airframe may be an aircraft structure (i.e. those parts of the craft excepting the avionics and the propulsion system).

Preferably, the rotor control component is configured to pitch (or alter the pitch of) one or more rotor blades of the rotor system. Suitably, the rotor control component is configured to activate rotation of the rotor system, or to activate the rotor system to rotate. It may be that the actuation of the rotor system does not actually activate or turn on the rotor system, but merely adjust its configuration.

The actuation of the rotor system may also be undertaken dynamically, so that a series of actuations of the rotor system follow one another. This may be undertaken in response to dynamically changing conditions requiring alteration of the flow over or around the airframe.

In an embodiment, the aircraft further comprises a plurality of sensors, which sensors operable to provide input to the rotor control component for modification of the aerodynamic flow. In an alternative embodiment, it may be that an actuation or series of actuations of the rotor system can simply be programmed for flight conditions, such as a period of time elapsed during flight, or a feedback from a part of the aircraft, such as a change in thrust by the thrust means.

Preferably, the control component comprises one or more inputs for receiving information from: the sensors; the rotor system; and the thrust means. There may also be inputs for receiving information from (the actuation of) control surfaces of the aircraft, such as stabilizers and trim surfaces.

Suitably, the airframe comprises a plurality of aerodynamic manipulation devices for additional modification of the aerodynamic flow.

In an embodiment, said portion of the airframe housing the rotor system comprises an aerofoil. Preferably, the wing section comprises said portion.

Suitably, at least one vertical lift rotor of the rotor system is housed in a ducted tunnel within said portion of the airframe.

In an embodiment, the rotor system comprises a plurality of vertical lift rotors. In addition/alternatively the rotor system may comprise plurality of rotor sub-systems, each of which comprising a plurality of rotors. The rotor systems may be actuated simultaneously, or individually.

Suitably, a proportion of the airframe in comparison to a diameter of the rotor system is configured such that a disk loading of the rotor system is in excess of 27 pounds per square foot. Preferably, the disk loading is in excess of 100 pounds per square foot.

In an embodiment, the rotor control component is configured to, on the aircraft entering the forward thrust mode, reduce a blade pitch of the rotor system to zero.

Suitably, the rotor control component is in addition configured to drive the rotor system to produce movement of the aircraft in directions away from a vertical lift axis.

One embodiment of another aspect of the invention can provide a control method for a vertical take-off and landing aircraft, the aircraft having a vertical motion mode and a forward thrust mode, the aircraft comprising: an airframe, comprising a wing section; a forward thrust means, for use during the forward thrust mode; and a vertical lift rotor system, the rotor system being housed in a portion of the airframe, the method comprising: during the forward thrust mode, actuating the rotor system to modify the aerodynamic flow around the portion of the airframe housing the rotor system.

One embodiment of another aspect of the invention can provide a vertical take-off and landing aircraft comprising: a main fuselage section; a left main wing extending from a left side of said fuselage and a right main wing extending from a right side of said fuselage; a lifting rotor that is shrouded within said left wing with its centre at a station location of less than 45 percent of the wing span dimension, and at least a second lift rotor shrouded within said left wing behind or slightly off-parallel line to the first rotor in relation to an overall longitudinal axis of the aircraft; a lifting rotor that is shrouded within said right wing with its centre at a station location of less than 45 percent of the wing span dimension, and at least a second lift rotor shrouded within said right wing behind or slightly off-parallel line to the first rotor in relation to the overall longitudinal axis of the aircraft; and at least two longitudinally aligned primary forward thrusters.

Preferably, the aircraft further comprises: a vertical stabilizer that extends from and/or is co-mounted with a rear horizontal stabilizer, or is mounted independently extending from a rearward section of the main and/or an ancillary fuselage, or near the rearmost section of an empennage.

Optionally, the aircraft further comprises: a horizontal stabilizer at the rear and/or the front of said aircraft, to provide additional pitch axis control authority.

Preferably, a main horizontal stabilizer is mounted near or on the upper section of said rearward mounted vertical stabilizer.

Suitably, the aircraft further comprises a rotor control component.

Preferably, the rotor control component is configured to provide like directional rotation of opposite pairs of said lifting rotors, with positioning of said pairs of lifting rotors rotation-matching in orientation to be diagonally opposite, or left side to right side opposite rotations, or front to back relative positions of opposite rotation, in dependence on an overall aircraft configuration and the total number of rotors.

Suitably, the aircraft further comprises: a controllable nose rotor mounted and contained within the nose section of said fuselage.

Preferably, the nose rotor is co-mounted and retractable in concert with the aircraft main nose-positioned landing gear assembly.

Suitably, the aircraft further comprises a controllable rear mounted rotor, the rotor either contained in or located and co-mounted with the vertical stabilizer.

In an embodiment, the aircraft further comprises a vertically oriented ventral fin structure below the rearward main fuselage or empennage.

Suitably, the rotor control component is configured to collectively and/or individually control a collective blade pitch pf the respective rotors, via a central flight processor (CFP) and stability augmentation system (SAS).

Preferably, the rotor control component and/or the CFP/SAS is further configured to convert the aircraft between normal forward flight and vertical landing flight modes.

Optionally, the rotor control component is further configured to modify the effective boundary layer air streams flowing around the lift rotor wing housings.

One embodiment of another aspect of the invention can provide a vertical take-off and landing aircraft having a substantially thick-chorded, blended and tapered main wing design, the aircraft comprising: a main fuselage section that is abbreviated near a main wings' trailing edge dimension; a main wing mounted on and extending from the left side of said fuselage, and from the right side of said fuselage; a left side tail boom empennage mounted to and extending rearward from the left main wing at a station location of at least 45 percent of the wing span dimension; a right side tail boom empennage mounted to and extending rearward from the right main wing at a station location of at least 45 percent of the wing span; a primary forward lift rotor embedded in said left main wing section with its centre located at a span station of 45 percent of the wing's span dimension from the centre of the main fuselage, and at least one other rotor embedded in said left wing section generally behind said primary forward lift rotor's mount, a primary forward lift rotor embedded in said right main wing section with its centre located at a span station of 45 percent of the wing's span dimension from the centre of the main fuselage, and at least one other rotor embedded in said right wing section generally behind said primary forward lift rotor's mount; wherein said at least two left side lifting rotors and said at least two right side lifting rotors are each configured to provide collective pitch control; and at least one primary forward thruster generally aligned with the primary longitudinal axis of said aircraft.

Preferably, the aircraft further comprises: a horizontal stabilizer at the rear and/or the front of said aircraft, to provide pitch axis control authority.

Optionally, the aircraft further comprises: a vertical stabilizer that extends from, and may be co-mounted with the rear horizontal stabilizer, to said tail boom empennages, and/or is mounted independently from the front horizontal stabilizer, and is mounted and extends from a rearward station location of the left and right empennages.

Preferably, the aircraft the aircraft, with reference to said vertical stabilizer mounted to said tail boom empennages, is configured to align the majority of the centred profile area between said empennages with the thrust flow of the thruster mounted in front of control surfaces at the rear of the abbreviated main fuselage.

Suitably, the aircraft further comprises a rotor control component.

Preferably, the rotor control component is configured to provide directional rotation of at least pairs of lifting rotors in the overall system, with positioning of said pairs of lifting rotors rotation-matching orientation to be diagonally opposite, or left side to right side opposite rotations, or front to back relative positions of opposite rotation, dependent on overall aircraft configuration and a total number of rotors.

Suitably, the aircraft further comprises: a controllable rotor mounted and contained within the main fuselage, in fixed position such that its resulting thrust force is operable upon the yaw axis of the aircraft; or optionally co-mounted and moving in concert with the aircraft main nose-positioned landing gear assembly.

Suitably, the rotor control component is configured to individually control each rotor's collective blade pitch.

In an embodiment, the aircraft further comprises: a central flight processor for augmenting the control and stability of the aircraft during hovering operations, and through the transitional flight modes between hover operations and forward, wing-born flight operations as well.

One embodiment of another aspect of the invention can provide a vertical take-off and landing aircraft, comprising: a main fuselage section; a left main wing mounted on and extending from the left side of said fuselage and a right main wing mounted on and extending from the right side of said fuselage; a left, sub-fuselage, lift rotor beam frame mounted on said left wing at a station location of at least 65 percent of the wing span dimension; a right, sub-fuselage, lift rotor beam frame mounted on said right wing at a station location of at least 65 percent of the wing span dimension; a left lifting rotor mounted forward on and above said left mounting beam frame; and at least a second left lifting rotor mounted rearward on but below said left mounting beam frame; a right lifting rotor mounted forward on and above said right mounting beam frame; and at least a second right lifting rotor mounted rearward on but below said right mounting beam frame; at least two left lift rotor systems and at least two right lift rotor systems, each having collective pitch control; at least one primary forward thruster generally aligned with the primary longitudinal axis of said aircraft and mounted aft of the empennage section.

Preferably, the aircraft further comprises: an ancillary horizontal stabilizer at the front of said aircraft in to provide pitch axis control authority.

Suitably, the aircraft further comprises: a V-Tail horizontal/vertical stabilizer mounted to and extending upward from the rear of an empennage section of the main fuselage.

In an embodiment, the aircraft further comprises a rotor control component.

Preferably, the rotor control component is configured to provide like directional rotation of at least pairs of lifting rotors, with positioning of said pairs of lifting rotors rotation-matching in orientation to be diagonally opposite, or left side to right side opposite rotations, or front to back relative positions of opposite rotation, in dependence on aircraft configuration a total number of rotors.

Suitably, the aircraft further comprises a controllable rotor mounted and contained within the main fuselage, in fixed position such that its resulting thrust force acts upon the yaw axis of the overall aircraft; or optionally co-mounted and moving in concert with the aircraft main nose-positioned landing gear assembly; or alternatively said controllable rotor is mounted in an additional vertically oriented lower ventral fin structure below the V-Tail assembly at the rear of the empennage.

In an embodiment, the rotor control component is configured to individually control each rotor's collective blade pitch.

Suitably, the aircraft further comprises: a central flight computer configured to augment the control and stability of the aircraft during hovering operations, and through the transitional flight modes between hover operations and forward, wing-born flight operations as well.

In embodiments, the wing or wing section comprises at least one articulated wing extension.

One embodiment of another aspect of the invention can provide a computer program application or a computer readable medium comprising computer program code adapted, when loaded into or run on a computer or processor, to cause the computer or processor to carry out a method according to the above described aspect.

The above aspects and embodiments may be combined to provide further aspects and embodiments of the invention.

### BRIEF DESCRIPTION OF THE DRAWINGS

The invention will now be described by way of example with reference to the accompanying drawings, in which:

FIG. 1 is an isometric view of a first embodiment of the invention, an aircraft design described herein;

FIG. 1a is an isometric half-view of the first embodiment of the invention of FIG. 1, illustrating an example of upper rotor housing closures;

FIG. 2 is a top view of the first embodiment of the aircraft design described herein;

FIG. 3 is a side view of the first embodiment of this aircraft. This will be referred to as Aircraft 1;

FIG. 3a is an underside partial isometric close-up view of the first embodiment of this aircraft according to an embodiment of the invention, illustrating examples of lower portions of the rotor housing closures;

FIG. 4 is an isometric view of a drive train according to an embodiment of the invention, combining gearbox with shaft drives shown;

FIG. 4a is a diagram illustrating a control system for embodiments of the invention;

FIG. 5 is an isometric view of a second embodiment of the invention, an aircraft design described herein;

FIG. 6 is a top view of the second embodiment of the aircraft design (Aircraft 2);

FIG. 7 is a side view of the second embodiment of said aircraft design;

FIG. 8 is a rear view of the preferred inverted V-Tail configuration of a second embodiment of the invention, for Aircraft 2, that will capture and take advantage of the thrust plume airstream from the thruster(s) for hover yaw control;

FIG. 9 is a rear view of a second tail configuration of Aircraft 2;

FIG. 10 is a rear view of a third tail configuration of Aircraft 2 also showing alternate thrusters;

FIGS. 11 to 13 are section views of an aircraft wing showing examples of rotor positions according to embodiments of the invention;

FIG. 14 is an isometric view of the third embodiment of the invention, of a dual system aircraft design as described herein. This design is referred to as Aircraft 3;

FIG. 15 is a top view of the third embodiment of this version of the aircraft design;

FIG. 16 is a side view of the third embodiment of Aircraft 3;

FIG. 17 is a rear view of Aircraft 3 with its movable wingtips according to an embodiment of the invention shown in normal flight mode and an optimized flight mode (dash lines) when they would behave very much like winglets in an upward facing position to reduce tip vortices and improve aircraft performance; and

FIG. 18 is a rear view of Aircraft 3 with its movable wingtips shown in the down-facing hover or landing mode position, according to an embodiment of the invention.

### DETAILED DESCRIPTION

Embodiments of the invention can provide aircraft and systems in which modification of the air flow around the airframe, for example the wing section containing the rotors, can be effected by the rotors themselves, by making small adjustments to the rotors during forward flight. This allows dynamic alteration of the drag profile of the aircraft during forward flight, which in turn provides more efficient forward flight. Embodiments of the invention also provide enhanced stability in hover flight; increased ability to traverse adverse terrain conditions; while offering complete flexibility to perform vertical flight operations verses conventional forward flight, rolling take-offs and landings. These are aircraft configurations that offer similar efficiencies of fixed wing flight, while having the capability to take-off or land in a parking lot.

None of the previously considered systems can satisfy the substantially wider range of capabilities that the present embodiments' aerodynamically morphing compound wing rotor assemblies can provide, nor the ultimate cruise speed efficiencies that can be had from such boundary layer air (BLA) manipulation as can be achieved. This along with the inherently more stable nature of the intentionally very high disk loaded (VHDL) rotor systems, which give greatly increased adverse weather and terrain handling characteristics, can all make this an airframe chosen for superior design in the realm of both unmanned and manned fixed-wing VTOL operations.

Embodiments of the present invention describe a vertical take-off and landing (VTOL) aircraft that has a greatly enhanced (i.e. much) safer conversion from vertical to horizontal flight. The design includes at least one main fuselage, a left wing form, a right wing form, significantly a version of separated forward thrust system from the dedicated vertical lifting rotor system, and some combination of horizontal and vertical stabilizers either fore or aft of the main wing assemblies. The at least one separated thruster will be mounted to the main fuselage, and multiple forward thrusters would be mounted about the main fuselage, or be mounted to sub-fuselage sections offset from the main fuselage, or be co-mounted in/to an enclosed lift-rotor housing section if so equipped.

More specifically one of two types of said separated vertical lifting rotor systems will be employed: either an enclosed, short-ducted housing type system or a group of exposed lifting rotor systems/assemblies. The enclosed rotor system will be typically mounted to the main wings with its primary rotor centre at less than 45 percent of each of the main wing's span dimension from the aircraft's main fuselage centreline/longitudinal-axis, and also take advantage of blended shape manipulations and enclosed housing enhancements therewith. In these embodiments, the tail boom locations essentially mimic the station locations of the airframe's commensurate lift rotor assembly stations. This is a structural advantage in order to best control the aircraft's overall empty weight fraction via efficient use of structural members.

In contrast, the exposed rotor systems will be mounted with their respective primary rotor centre farther out from the aircraft's primary centreline located at a span station at least 65 percent of each main wing's span dimension. Exposed lift rotor systems typically need to be mounted further outboard from a main fuselage in order to minimize whatever unwanted aerodynamic couplings that may occur during transitional and possibly cruise flight conditions as well. Exposed rotors typically need to have an ample amount of clean uninterrupted air of their own to be most effective and efficient themselves as lift rotors.

Articulating wing (tip) extensions located further outboard of these exposed rotor mountings will add wingspan and reduce wing loading and participate in morphing the aircraft's boundary layer flow shape in these localized wing section areas between hovering and forward flight modes. Even more significantly, these exposed rotors may be alternately mounted above and below the main wing sections chord line, fore and aft respectively, in order to cause further localized lift augmentations during VTOL, hover, and slow flight operations. During cruise flight, the rotor heads of the exposed rotor systems will allow for the blades to be swept back into less obtrusive frontal area positions thereby reducing the parasitic drag as much as possible without adding more complex covers and or retracting mechanisms to those rotor assemblies. The forward rotors will be above the main wing's chord lines and the aft rotors below by a same margin. Their respective turbulent airflows will thus not be directly interacting, which would compound the local slipstreams and cause even more drag otherwise. Instead, each rotor's post slipstream will be able to straighten quicker and not contribute to a further increase in the already challenging parasitic drag condition that will exist.

In the lifting rotor systems described herein, each rotor mechanism will employ fully controllable collective pitch function. Each rotor's diameter is relatively small in percentage of overall aircraft wingspan ratio and the resulting disk load that each carries. The disk loading is a result of the amount of overall rotor area(s) combined that are supporting the aircraft's gross weight. Comparatively, typical rotorcraft design airframes, i.e. helicopter, realize an approximate disk loading of as little as just under 3 pounds per square foot for light utility helicopters to 15 pounds per square foot for heavy lift type helicopters, and to include a high of almost twice that for the V-22 Osprey tilt-rotor airframe at roughly 27 pounds per square foot. These disk loadings while producing highly efficient hover equations suffer from greatly reduced forward flight characteristics. The disk loading of embodiments of the present invention is in excess of 100 pounds per square foot. While these very high disk load (VHDL) rotor systems are comparably less efficient during hover operations, they in-turn offer significant advantages due to the nature of the aerodynamics at work.

In embodiments of the invention, the disk loading of the rotor system may be at least 27 pounds per square foot, but is typically at least 50-75 ppsf, and preferably greater than 100 ppsf.

The intent of embodiments of the present invention is to produce an airframe that has the flexibility to perform vertical take-off and landing manoeuvres as well as pure hover operations when necessary for any particular mission. Part of said advantageous flexibility is that this VHDL system is far less affected by adverse weather conditions or higher winds. Exit velocities of the lift rotor air streams are more concentrated and not as affected by otherwise troublesome cross winds. Traversing an adverse terrain such as cliff sides and other potential in/out of ground effect conditions are much easier handled with a VHDL system such as embodiments of this invention employs. Although unable to hover over less prepared surfaces directly at low, close-proximity altitudes, most hover operations work as such can simply be carried out at slightly higher above ground level (AGL) altitudes which quickly mitigates the higher velocity flow stream effects on the grounds below.

The further intent of embodiments of the present invention is to also realize much more efficient forward flight efficiencies once it converts to forward flight “on the wings” being able to cruise at significantly higher speeds than any traditional rotorcraft (as much as 3× or more) while also benefiting from the other known advantages of wing born flight such as extended range via speed and reduced wing loading (exchanged for high disk load hover) and the ability to fly at higher altitudes, which also provides the option to fly over adverse weather conditions as well, unlike helicopters. Comfort and the additional safety/redundancy of having wings allows the aircraft to glide to safe landings should there be engines or VTOL systems failures. Embodiments of the present invention effectively combine these two individually known and proven types of aircraft lifting and thrusting systems to create a VTOL aircraft with unprecedented range and flexibility of operations due to its increased speeds and greater amount of inherent stability.

The vertical take-off and landing (VTOL) aircraft configuration of embodiments of the invention includes: a primary, but usually asymmetrically shaped fuselage; at least one relative left side and one right side mounted fixed wing or plurality of fixed wings, that are attached to said fuselage at either substantially fore or aft and or above or below of the respective longitudinal and lateral axes; alternative or secondary, multiple or ancillary fuselage sections preferably mounted substantially offset from the primary fuselage or from each other relative to the longitudinal axis; and a propulsion system or systems with resulting thrust being primarily aligned with the longitudinal axis of the overall aircraft configuration, and which are mounted onto or within the primary or ancillary fuselage sections dependent on the exacting aircraft configuration.

In embodiments, the rotor(s) may not necessarily be longitudinal-axially aligned, depending on the aircraft configuration and the total number of rotors being employed. In embodiments, the thruster may or may not be longitudinally aligned directly behind the rotor or rotor system, depending on the configuration.

A multitude of lifting rotors will be oriented substantially horizontally and in relatively co-planar position such that resulting thrust (lifting force) is primarily aligned with the vertical axis of the overall aircraft configuration. One embodiment structure encompasses said lift rotors and provides each rotor assembly with a brief ducted tunnel, and which overall shape is blended between all said rotor ducts, and further contains controllable aerodynamic manipulation devices including variable vortex generating shapes, spoilers, and slats, all of which work in conjunction that result in complete boundary layer air (BLA) manipulation in order to mitigate the parasitic drag caused by such a plethora of horizontally oriented, edge-wise flying rotor systems. This is a method by which the ultimate slipstream shape is “morphed” into a more efficient resultant shape during various cruise flight speeds and altitudes.

One or more vertical stabilizers will be mounted to the primary and or also the ancillary fuselage sections. A horizontal stabilizer, if necessary, will be mounted forward of the above mentioned wings or aft of the same dependent on aircraft mission and design payload/deployment, aircraft balance, and stability and control requirements. The primary advantage of this aircraft configuration is to combine the flexibility of vertical take-off and landing operations if needed or desired with true hover capabilities, together into an airframe with a much higher cruise speed being made possible by the integrated compound “morphing” wing assemblies. Simply put: an aircraft providing fixed-wing speeds and similar cruise flight efficiencies, while offering the ability to take-off and land from a parking lot or typical helipad.

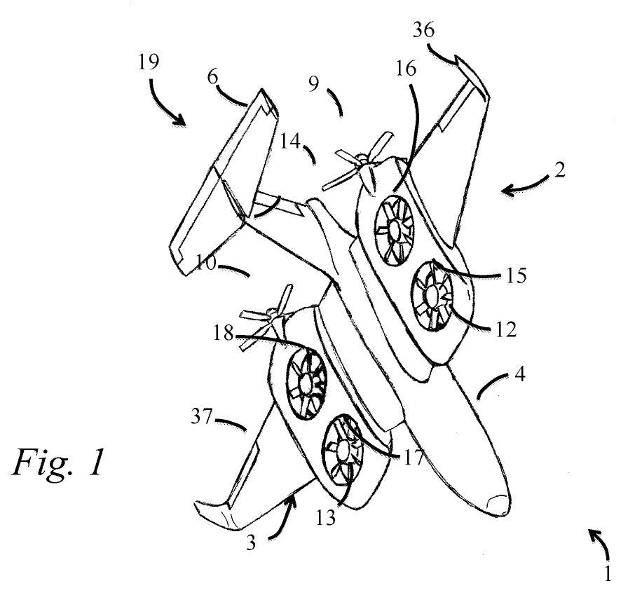

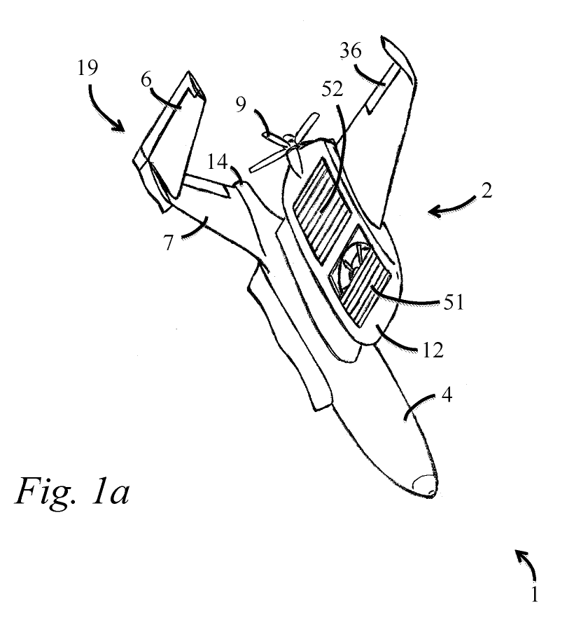

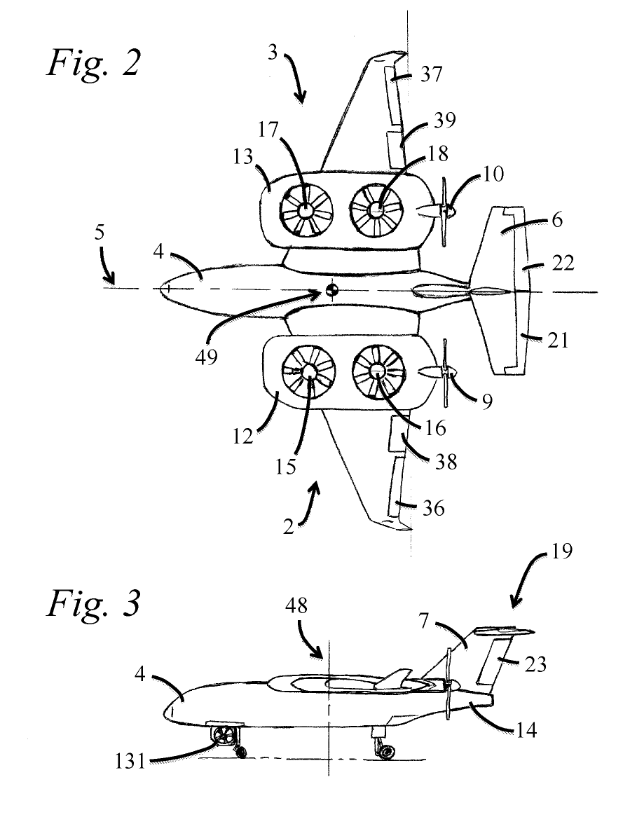

The VTOL Aircraft 1 (1), referring to FIG. 1, is comprised of a main fuselage (4), a right (3) and left (2) main wing section, a minimum of two forward thrusters, a left side thruster (9), and right side thruster (10) are aligned to the primary longitudinal axis, FIG. 2 (5), and a fore and or an aft mounted horizontal stabilizer (6) and a vertical stabilizer (7), or alternatively the horizontal and vertical stabilizers may be replaced with a form of upward or downward facing V-Tail assembly (i.e. 208). The left main wing (2) mounts onto the main fuselage (4) and or is extended from the left side of the main fuselage (4), and the right wing (3) as well, mounts onto the main fuselage (4) and or is extended from the right side of the main fuselage (4). The at least two forward thrusters (9, 10) are preferably mounted aft-ward on the empennage section (14) either by means of extended pods (not shown) or like structures typically used to secure engines and or thrust devices (9); or alternatively, these forward thrusters (9, 10) may be mounted locally fore or aft onto the respective left and right side lift rotor housing sections described below, at least one on each of the said left and right housings and still aligned with the primary longitudinal axis (5) of the overall aircraft. Although preferably gear-driven propellers, said thrusters (9, 10) may be axial jet engines or turbofan, high-bypass type jet engines.

Mounted to the left main wing (2) is a left lift rotor housing section (12), and mounted to the right main wing (3) is a right lift rotor housing (13). The left lift rotor housing (12) encompasses and retains at least two preferably collective pitch lifting rotors assemblies (15, 16), and the right lift rotor housing (13) also encompasses and retains at least two preferably collective pitch lifting rotor assemblies (17, 18). The vertical stabilizer (7) mentioned above is preferably mounted and extends upward from an aft station location of the empennage (14) of the aircraft. The horizontal stabilizer (6) is preferably mounted to the uppermost portion of said vertical stabilizer (7) forming what is largely known in the art as a “T-Tail” assembly comprising of both horizontal and vertical stabilizing and control surfaces (19). Said control surfaces are comprised of; an elevator or elevators (21, 22) that are attached and pivot to/on the horizontal stabilizer (6), and a rudder or rudders (23, 24) that are attached and pivot to/on the vertical stabilizer (7). A left aileron (36) that is attached and pivots to/on the left main wing (2) at a more outboard station location, a right aileron (37) that is attached and pivots to/on the right main wing (3) at a more outboard station location, a left flap mechanism (38) that is attached and pivots to/on the left main wing (2) at a more inboard station location, and a right flap mechanism (39) that is attached and pivots to/on the right main wing (3) at a more inboard station location.

All of said thrusters (9, 10) and lifting rotors (15, 16, 17, 18) are powered, and or driven, and rotate via a central transmission system, commonly known in the art as a combining gearbox, centrally mounted in the main fuselage (4), and which the engine or engines (25) are mounted to as well, and then through subsequent drive shafting (26) and ancillary gear boxes (27) at or near each individual rotor assembly. Alternatively, a hybrid fuel engine driven electric generation system may power specific electric drive motors (28) located and likely alternatively mounting each respective rotor assembly that they are driving. The fuel engine (25) will drive a generator (not shown) that will in turn charge and maintain the power level of a main battery storage bank (not shown) which then in turn powers said electric motors at each rotor location. The battery bank will also serve as boost power source when extra torque is needed during what is known in the art as “hot and high” hover and or flight operations, or other like situations that may require extra torque to be delivered to said system.

Hover flight attitude of VTOL Aircraft 1 (FIG. 1) is controlled via conventional type physical pilot interface controls (not shown), i.e. typical hand yoke or centre stick controls for pitch and roll attitudes, rudder pedals for yaw axis control, and throttle and pitch control levers or knobs alike to control the thruster forces and or pitch settings. The collective, collective lifting rotor pitches, where the overall lift of the at least four total lifting rotors is controlled via one lever/knob. As a whole, the onboard flight control system is known as a “fly by wire” system, whereby inputs from the physical pilot controls as described above, are sensed by a main central flight processor (CFP) which is not shown, that in-turn drives the respective control surfaces, the various lift rotor and or propeller collective pitch mechanisms, and the engines all via servo motors specifically calibrated to actuate each. Further, within the CFP is an enhanced internal measurement unit coupled to a redundant sensor array that is altogether called the Stability Augmentation System (SAS). This comprehensive SAS (not shown) comprises of multiple (and redundant) gyroscopes, accelerometers, temperature, barometric, and as well as linear sensors that all work together between the pilot and the actual flight control surfaces, propellers, rotors, and engines to provide various intermediate control inputs in order to greatly reduce the pilot's work load, particularly during flight operations in more adverse conditions. The pilot has full authority of the control input, but as he or she holds said controls steady, the CFP/SAS takes care of the finite and maintaining control adjustments that keep the aircraft in the intended attitude and orientation during hover operations. This may be thought of or described as an autopilot function for hovering.

It should be noted here that in this and other specific embodiments described herein, the lifting rotor assemblies (15, 16, 17, 18) are each controllable to be collectively pitched, but are not turnable or able to tilt within the rotor housing or wing section. In alternative embodiments, it may be that an alternative rotor assembly can be used which is able to both collectively pitch its rotor blades, and also to tilt or rotate the rotor within the housing.

There are selectable flight modes and also the CFP/SAS has the ability to discern appropriate flight mode selection depending on aircraft speed, altitude, and orientation. During hover mode operations, when the pilot moves the control yoke or stick forward the aircraft moves forward and maintains a level pitch and roll axis attitude. When the pilot pulls back on the stick in hover mode, the aircraft moves rearward which again maintaining level pitch and roll axis attitudes. If the forward and indeed reversible thrusters (9, 10) are somehow disabled or inoperative, or further by specific pilot choice, an alternative hover control mode is automatically or selectively activated whereby the aircraft pitch and roll axis attitudes are effectively manipulated in order to manoeuvre the aircraft in hover. When the pilot moves the control yoke or stick forward in this alternate hover flight mode the collective pitch of the at least two rearward lift rotors (16, 18) is slightly increased while the collective pitch of the at least two forward lifting rotors (15, 17) is slightly and simultaneously decreased which acts upon the CG (49) of the aircraft to lower the nose and to enact differential forces that result in a forward aircraft motion. This is similar to a helicopter pilot cyclically tipping its main rotor forward with its respective control stick thereby causing its fuselage to nose down while moving the helicopter forward as well. When the pilot moves the control yoke or stick rearward in the aircraft in this alternate hover flight mode the collective pitch of the at least two rearward lift rotors (16, 18) is slightly decreased while the collective pitch of the at least two forward lifting rotors (15, 17) is slightly and simultaneously increased which acts upon the CG (49) of the aircraft to raise the nose and to enact differential forces that result in a rearward aircraft motion. It is to be noted as well, that in this alternative hover flight mode, a forward flight speed of at least one third of the aircraft's normal cruise velocity can be achieved by pitching the nose down as described just above and subsequently controlling the aircraft attitude via its normal aerodynamic surfaces. This is an effective backup and potential safety procedure that a pilot can employ should the main thrusters be disabled or somehow become inoperative.

Augmenting the control and stability of the aircraft during take-off and landing operations can be achieved with said CFP/SAS. Stability augmentation is provided while a pilot converts flight modes between hover operations and forward, wing-born flight during take-off. The CFP/SAS will handle said conversion and flight mode changes providing redundancy and added safety to these operations. Likewise, during a landing operation, the CFP/SAS will automatically convert the aircraft between normal forward flight and vertical landing flight modes.

Returning to aircraft attitude control during normal hover operations: When the pilot rotates the control yoke clockwise or moves the control stick to the right, the collective pitch of the at least two left side lifting rotors (15, 16) is slightly increased while the collective pitch of the at least two right side lifting rotors (17, 18) is slightly and simultaneously decreased which acts upon the CG (49) and roll axis of the aircraft to lower the right wing (3) and raise the left side wing (2) enacting differential forces that result in the aircraft moving sideways toward the right. When the pilot rotates the control yoke counter-clockwise or moves the control stick to the left, the collective pitch of the at least two left side lifting rotors (15, 16) is slightly decreased while the collective pitch of the at least two right side lifting rotors (17, 18) is slightly and simultaneously increased which acts upon the CG (49) and longitudinal roll axis (5) of the aircraft to raise the right wing (3) and lower the left side wing (2) enacting differential forces that result in the aircraft moving sideways toward the left. To effect purposeful rotation or anti-rotation control about the aircraft's yaw axis the pilot will use the conventional rudder pedals at his feet. To turn or yaw the aircraft to the right, the pilot depresses the right pedal into the floor toward the front of the aircraft and the left pedal comes back toward the pilot given the usual expected push-pull bell-crank mechanism action that is employed in these systems. To turn or yaw the aircraft to the left, the pilot depresses the left pedal into the floor toward the front of the aircraft and the right pedal comes back toward the pilot given the usual expected push-pull bell-crank mechanism action that is employed in these systems. In hover modes the yaw attitude, or aircraft heading (compass direction), is maintained by the CFP/SAS by default. But the pilot can turn and point the aircraft at will, and once the rudder pedals are released again the CFP/SAS immediately maintains the new heading. One or a combination of up to three methods are being employed to actually yaw the aircraft. Primarily, the yaw control comes from the differential control of the at least two thrusters (9, 10). Yawing commands to rotate the aircraft to the right slightly increasing thrust from the left thruster (9) while decreasing thrust or even reversing thrust from the right thruster (10). Yawing commands to rotate the aircraft to the left slightly increasing thrust from the right thruster (10) while decreasing thrust or even reversing thrust from the left thruster (9). Secondarily, yaw control is effected and or enhanced by the CFP/SAS creating an unbalanced rotational torque force between opposite spinning rotor pairs; either by increasing collective pitch of opposite diagonally oriented rotor pairs (i.e. 15 & 18) and decreasing the collective pitch of the 90 degree axis relative pair (i.e. 17 & 16), or by simple increasing the RPM of said first pair and decreasing the RPM of the 90 degree axis relative pair alike. Thirdly, yaw control is enhanced by use of the ancillary nose or rear mounted controllable rotor (31, 32) that is oriented to produce turning forces toward the sides of its mounted position. This force moment acts upon the CG of the aircraft (49) to cause a yaw rotation about its vertical axis (48), functioning much like a helicopter tail rotor does to counter the torque force of its main rotor and or sideways wind forces.

This provides yaw axis control via what is known in the art as “blown tail” effect whereby the tail mounted control surfaces enact forces on the aircraft during hover via some amount of thruster air flow as they would in relative wind flow in forward flight.

Further, the CFP/SAS actually maintains the position, heading, and altitude of the aircraft by default in the hover modes. The pilot can disengage this automatic attitude control manually if necessary or if desired. As part of an enhanced CFP/SAS feature, the aircraft has a plethora of forward and back, as well as side to side proximity sensors that serve to feed collision avoidance warnings and feedback to the pilot and the system itself. Once again, by default, the system will not allow the aircraft to come into contact with obstacles in its surroundings. This too, may be adjusted or even disabled if desired or necessary. Finally, the CFP/SAS system itself can (auto) pilot the aircraft completely autonomously. The system will be used in sub-scale versions of the aircraft designed to serve as unmanned aerial vehicles (UAVs), to be used for many mission sets that already exist, and to improve and even open many more types of applications offering unmatched controllability and safety to UAV operations.

Forward/Cruise flight attitude of VTOL Aircraft 1 (FIG. 1) is controlled via the same conventional type physical pilot interface controls (not shown), mentioned above. Again i.e. typical hand yoke or centre stick controls for pitch and roll attitudes, rudder pedals for yaw axis control, and throttle and pitch control levers or knobs alike to control the thruster forces and or pitch settings.

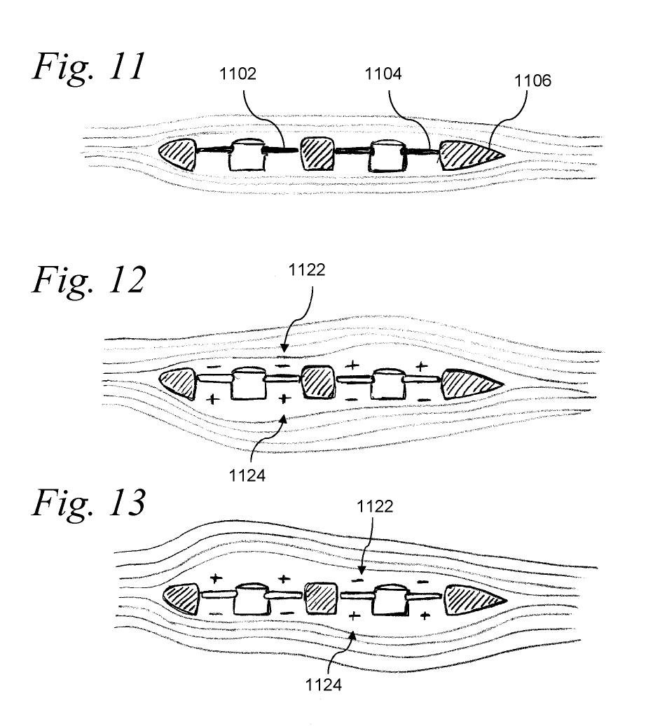

FIGS. 11 to 13 are section views of an aircraft wing showing examples of rotor positions according to an embodiment of the invention. It generally depicts the basic gross slipstream behaviour that will occur by simply sealing the rotor holes with the still spinning, but with zero-angle collective pitch setting. FIG. 12 generally depicts the basic gross slipstream behaviour that will occur by differentially pressurizing the front to back rotor holes in a way that would trim or pitch the nose down. FIG. 13 generally depicts the basic gross slipstream behaviour that will occur by differentially pressurizing the front to back rotor holes in a way that would trim or pitch the nose up.

Once the pilot/CFP/SAS converts the aircraft to cruise flight mode, the lifting rotor (1102, 1104) collective pitches are lowered or reduced to a zero pitch blade angle setting so as to nearly eliminate the power draw on the overall drive train (FIG. 11). They remain spinning but under nominally no load to the system at zero pitch. This serves to aerodynamically seal their hole through the housing wing section.

At cruise flight speeds then the collective and or individual collective pitches of the lift rotors are automatically slightly adjusted or manipulated by the CFP/SAS, thereby causing differential pressure zones in/at each rotor hole area, which in turn changes the slip stream airflows flowing over and under these areas, so as to move the aircraft's effective aerodynamic centre of lift by the resulting boundary layer air manipulation. This is enacted by said differential pressures in each rotor hole being created by the differing pitch settings (as shown in FIG. 12 and FIG. 13). This causes the resultant effective shape change of this section of the wings (1106) in cruise flight, thus moving the effective aerodynamic centre of lift of these sections, which finally results in a further reduced drag condition to improve the aircraft performance.

In an example (FIG. 12), a forward lifting rotor (1102) collective pitch setting may be set to a slightly higher lift setting from its neutral flat-pitch, no-lift setting. This results in a lower localized pressure (1122) above this rotor at its upper housing opening, while simultaneously increasing the pressure (1124) under the rotor at the lower surface opening. The sum of pressures creates a bubble or bulge effect to occur in the relative wind stream of boundary layer air flow thus altering its ultimate shape at cruise speeds. Coinciding with a forward lift rotor being set as described, an accompanying rearward lift rotor can be set to an opposite condition having its collective pitch set to a negative lift or balancing mode thereby creating higher localized pressure above its upper rotor housing opening and subsequently lesser localized pressure below its lower rotor housing opening. The result of these differing localized pressure regions in fact then serves to alter the overall boundary layer air streams thus aerodynamically changing the effective aerofoil shape during cruise flight. FIG. 13 illustrates the opposite effect; this time the rearward lifting rotor (1104) collective pitch setting is set to a slightly higher lift setting, which results in a lower localized pressure (1122) above this rotor and increased pressure (1124) under the rotor. The forward lift rotor (1102) is set to the opposite condition.

This wing shape morphing at cruise speeds subsequently allows or causes the aircraft to be trimmed to a more efficient drag profile thereby increasing range, speed, or capacity in a combination thereof. Once again, the pilot has full authority of the control inputs and the CFP/SAS system and can fly the aircraft manually, if desired. However, by default the CFP/SAS takes care of the finite rotor pitch adjustments that keep the aircraft in an optimized aerodynamic condition during cruise flight operations. This all in addition to the typical autopilot functions to maintain course heading and navigation parameters as well, or course. It should be noted as well that the CFP itself in addition to the SAS both have redundant processors and sensor arrays accordingly. This adds even more redundancy and safety to the overall aircraft operations.

The CFP/SAS system can automatically adjust the morphing of the air flow by these means in one or more ways. In an embodiment of the invention, forward flight mode cruise speeds are used to trigger the CFP/SAS to modify or morph the airflow by rotor pitch manipulation, and to set the amount, rate and timing of the rotor manipulation. For example, a given airframe will have aerodynamic characteristics which can be determined during testing. It can therefore be predetermined that at a particular cruise speed for the airframe in question, a particular change in airflow typically occurs, such as an increase in drag at a particular area of the airframe. Thus this particular cruise speed can be used as the trigger to begin a rotor control routine, and the amount of rotor pitch to be used can be predetermined by the type of change in airflow; the appropriate pitch change can again be predetermined in testing. The current cruise speeds of the aircraft used for the triggering function can be measured by sensors on the aircraft, or by measuring the current thruster output, for example.

In embodiments, a set of cruise speeds and the associated pitch changes required are available to the CFP/SAS system. In addition, sensors mounted on the airframe (particularly around the area of the rotor systems, e.g. 12 in FIG. 1) can measure the current drag experienced in flight, and if necessary report this to the CFP/SAS, so that it can be determined whether the drag value differs from that expected according to the predetermined airflow profiles corresponding with given cruise speeds. If the drag value does differ, the CFP/SAS can instruct an appropriate change to the rotor pitch to (further) modify the airflow.

In an alternative embodiment, the drag measurements and adjustments to the pitch of the rotors may be done entirely on the basis of sensors in this manner, without any predetermined cruise speed triggers being required. In other embodiments, assessments or measurements of ambient conditions may be used to modify predetermined values such as trigger cruise speeds or drag values requiring predetermined pitch modifications. In still other embodiments, input from crew may be used to modify the assessment performed by the CFP/SAS, for example if the crew has been informed that a particular weather system is approaching, which may not yet have been detected by sensors on the aircraft.

In other embodiments, the CFP/SAS is programmable to achieve different efficiency outcomes for particular journeys; fewer/more or different adjustments may be made for a faster journey, as compared to a journey in which fuel efficiency is more important.

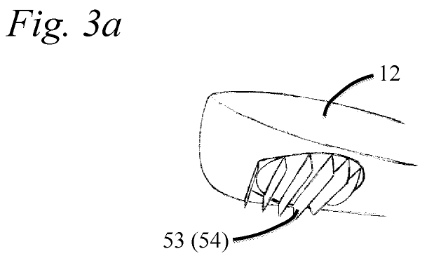

FIG. 1a is an isometric half-view of the first embodiment of invention of FIG. 1, illustrating an example of rotor housing closures. FIG. 3a is an underside partial isometric close-up view illustrating an example of lower portions of the rotor housing closures. In embodiments of the invention, the rotor housings set within the wings of the aircraft can be provided additionally with slats, shutters or louvres to improve management of the airflow over the rotor systems. As shown in FIG. 1a, retractable shutters or louvres 51 and 52 can be provided to enclose the rotors, for example to minimize drag which may otherwise be caused by the rotors being partially accessible to airflow over the wings. FIG. 1a shows louvre 52 in the fully closed position, and 51 partially retracted. FIG. 3a shows the underside of the louvre arrangement, with lower louvres 53/54 coupled to the underside of the rotor system shaft in the wing 12. In this embodiment, the louvres are able either to be disposed away from the wing to intervene in the airflow, as shown in FIG. 3a, or to be flattened against the wing, providing an enclosure of the rotor system shaft.

These louvre features can be used in addition to the control of the rotor pitches to further modify the airflow around the airframe in which the rotors are housed. For example, the rotors typically in normal flight will either be activated by the control component to pitch to modify airflow, or be idle (usually freely spinning). In cases where the rotors are idle, and perhaps are likely to be for some time, determinable according to a cruise speed or flight pattern, the louvres can be used to completely enclose the rotors while they are not in use. In addition, the louvres can be used cooperatively to provide additional control of the airflow; the rotors can be used to modify the airflow using the collective pitch, and the louvres can for example be used to provide fine control of the incidence of the airflow onto the rotors providing the modification. The shutters (in particular) and louvres can thus be used to optimize the cross sectional wing chord shape of the rotor housings of the aircraft for the cruise flight regime, and add separated and differing closure devices to physically inhibit any flow streams from entering the rotor housing openings.

Other types of aerodynamic manipulation devices may also be used for additional modification of the aerodynamic flow. For example an extendable spoiler (not shown) may be used to disrupt laminar flow accelerating over and into the forward inlet rim area of the lift rotor housing opening (12, 15/16) thereby mitigating a large pitch up moment that may be caused by super-accelerated airflow into that rotor housing opening. Dependent on the configuration of the aircraft, and its relative design specifications, this can also be achieved by employing vortex generators (also known as VGs) that are appropriately positioned prior to and around the rotor housing inlet areas. A group of retractable VGs could be employed to change the laminar flows in these areas during different stages of flight, i.e. specific VGs can be retracted during cruise flight operations, but be deployed during slow speed flight or transitional flight operations (to and/or from hover flight).

Another performance enhancing method to be utilized can be to use bleed compressor or ancillary compressor air to create BLA altering air curtains over and about various locations of the lift rotor housings (12, 15/16) and their respective rotor openings. Air blast curtains can effectively cut off from and/or extend laminar flows over and/or around said openings in order to again manipulate the boundary layer air streams in such a way as to decrease the overall parasitic drag of each lift rotor housing assembly, and/or be part of an overall manipulation of the cruise speed related boundary layer air streams.

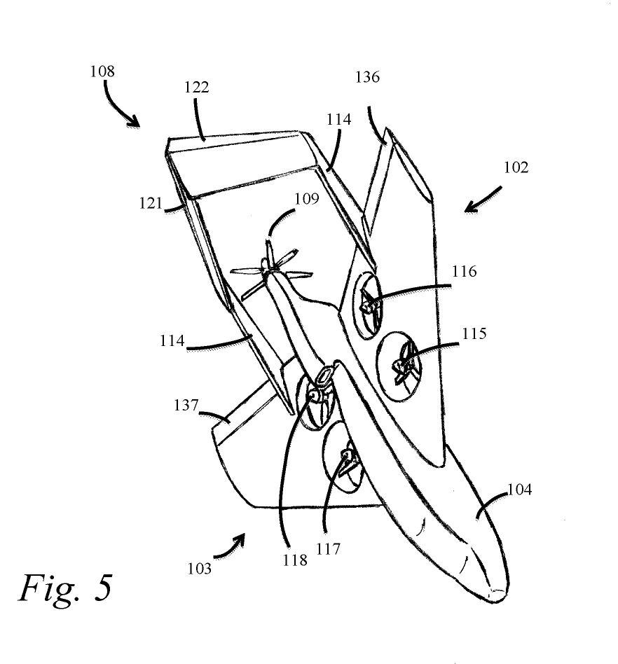

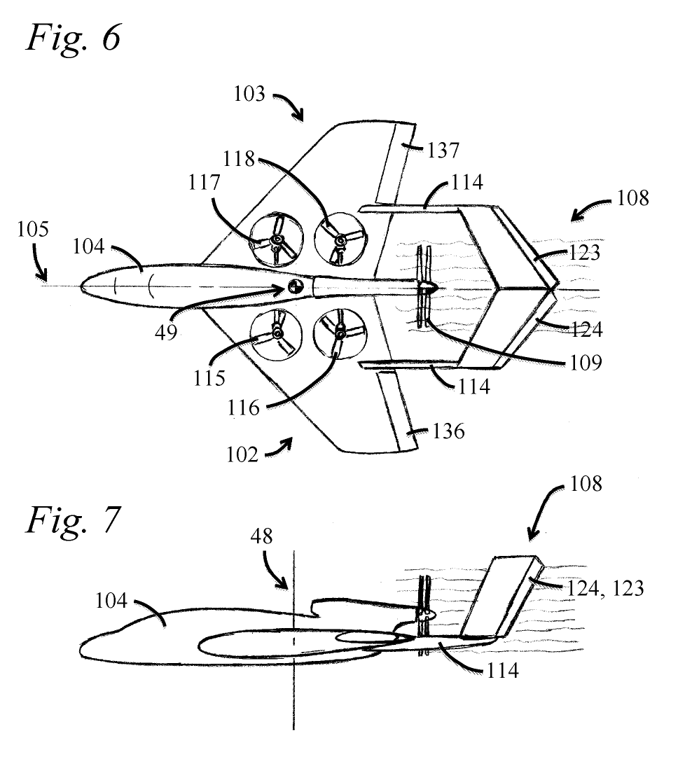

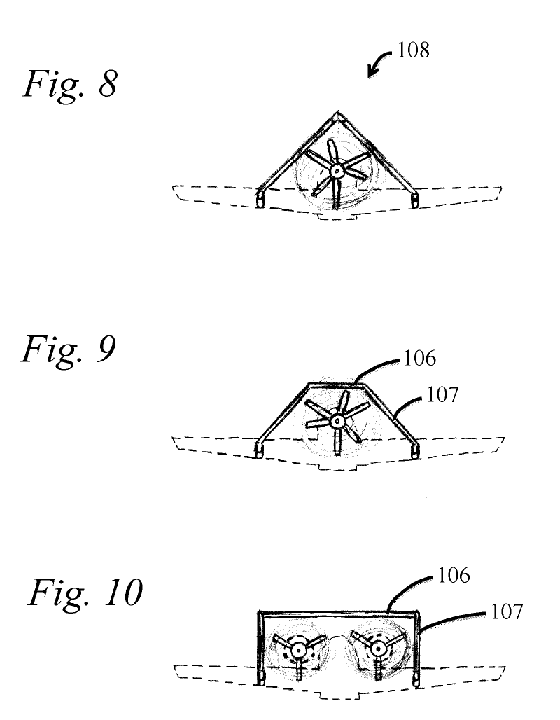

The VTOL Aircraft 2, referring to FIG. 5, is comprised of a main fuselage (104) that is abbreviated and terminates shortly aft of the trailing edge wing dimension at the root, a right (103) and left (102) main wing section, at least one forward thruster (109) aligned to the primary longitudinal axis (105), and a fore and or an aft mounted horizontal stabilizer (106) and a vertical stabilizer (107), or alternatively the horizontal and vertical stabilizers may be replaced with a form of upward or downward facing V-Tail assembly (108). The left main wing (102) mounts onto the main fuselage (104) and or is extended from the left side of the main fuselage (104), and the right wing (103) as well, mounts onto the main fuselage (104) and or is extended from the right side of the main fuselage (104). The at least one forward thruster (109) is preferably mounted aft in or on the rear section of the fuselage (104). Although preferably using dual-plane, contra-rotating propeller assemblies in order to mitigate single propeller torque affect, said thruster (109) may also employ an appropriate single propeller assembly, or be an axial jet engine, or a turbofan high-bypass type jet engine. The height location and exact mounting of the thruster (109) is such that its flow streams pass through the profile area of the aft mounted horizontal and vertical stabilizer(s), or V-Tail assemblies as shown in FIGS. 8, 9, and 10 which show these tail control surface structures capturing or surrounding the thruster flow stream plume in each case.

Said left main wing (102) is of a highly blended and swept design such that the root of the wing is substantially thick chorded so as to enclose and incorporate lifting rotors and drive systems thereof. In embodiments of the invention, the thick-chord nature of the wing allows extended enclosure of the lifting rotors, which allows full control of their airflow modifying features, whilst minimizing excessive drag from airflow which might otherwise interact with the rotors (for example, if a thinner chord were used). The thick chord also provides a longer duct for each rotor, which can provide greater control of the lifting/pitch thrust provided by the rotor when used to modify the airflow during forward thrust.

Mounted in the left main wing (102) is a left lift rotor (115), and mounted in the right main wing (103) is a right lift rotor (117). The left wing (102) provides mounts and retains at least two preferably collective pitch lifting rotors assemblies, a generally forward rotor (115) and generally rearward rotor (116) that is positioned generally behind said forward rotor; and the right wing (103) also provides mounts and retains at least two preferably collective pitch lifting rotor assemblies, a generally forward rotor (117) and generally rearward rotor (118) that is positioned generally behind said forward rotor. Twin tail boom empennage sections (114) extend from and are mounted from the left and right main wings (102, 103). Vertical stabilizers (107) are preferably mounted and extend upward from an aft station location of the empennages (114) of the aircraft. They may extend generally perpendicular upward from said tail booms and or partially or fully downward from said tail booms. They may also extend up or down at generally 45 degree angles and be joined at the vertical centre datum plane of the aircraft in order to form what is known in the art as an upward or inverted V-Tail assembly. In the case of utilizing either of said V-Tail assemblies, there is no rearward mounted horizontal stabilizer (106). When a rearward horizontal stabilizer (106) is preferable it is mounted to the uppermost portion of said vertical stabilizers (107) that are more generally upward and perpendicularly mounted from the aft portion of the tail booms. Said control surfaces are comprised of; an elevator or elevators (121, 122) that are attached and pivot to/on the horizontal stabilizer (106), and a rudder or rudders (123, 124) that are attached and pivot to/on the vertical stabilizers (107); In the case of a V-Tail assembly, the control surfaces are known as “rudevators” as they perform the function of both rudders and elevators when used on a V-Tail configuration; The rudevators (123, 124) are attached and pivot to/on the vertical stabilizers (107); A left aileron (136) that is attached and pivots to/on the left main wing (102) at a more outboard station location, a right aileron (137) that is attached and pivots to/on the right main wing (103) at a more outboard station location, a left flap mechanism (not shown) that is attached and pivots to/on the left main wing (102) at a more inboard station location, and a right flap mechanism (not shown) that is attached and pivots to/on the right main wing (103) at a more inboard station location.

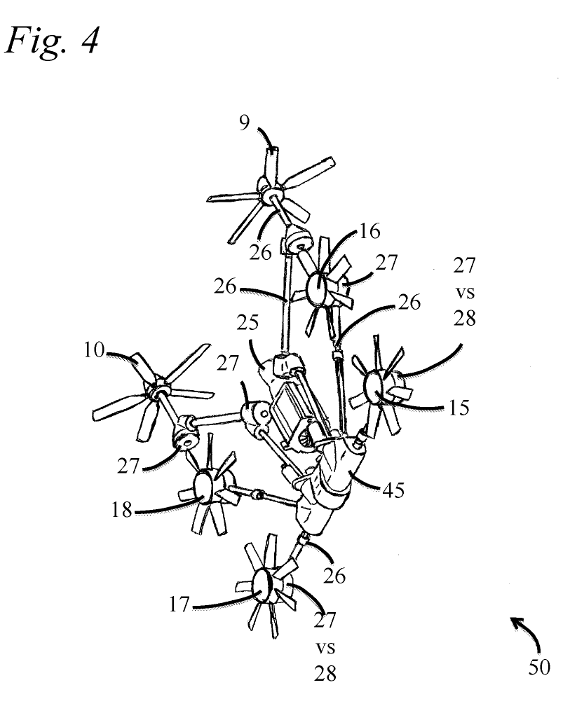

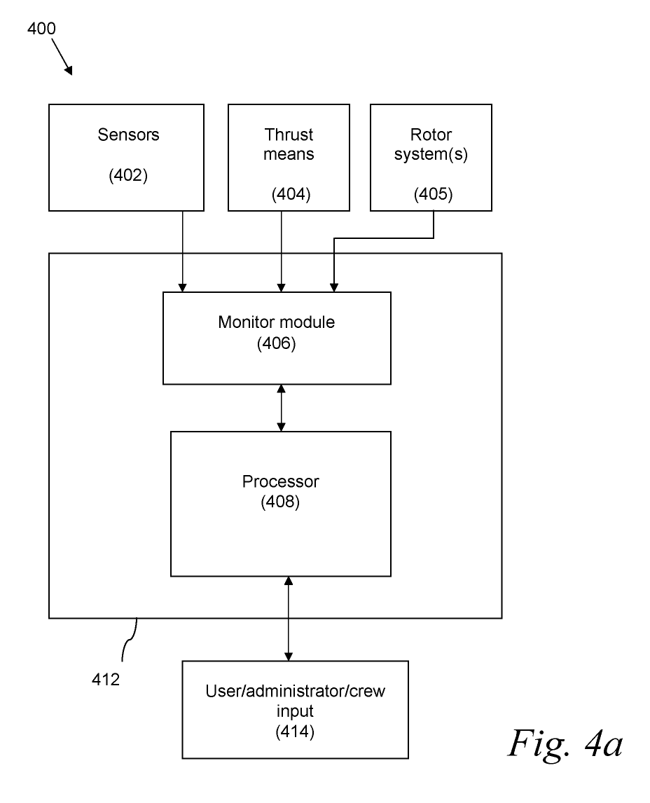

The said thruster (109) and lifting rotors (115, 116, 117, 118) are powered, and or driven, and rotate via a central transmission system (50) referring to FIG. 4, commonly known in the art as a combining gearbox (45), centrally mounted in the main fuselage (104), and which the engine or engines (25) are mounted to as well, and then through subsequent drive shafting (26) and ancillary gear boxes (27) at or near each individual rotor assembly. Alternatively, a hybrid fuel engine driven electric generation system may power specific electric drive motors (28) located and likely alternatively mounting each respective rotor assembly that they are driving. The fuel engine (25) will drive a generator (not shown) that will in turn charge and maintain the power level of a main battery storage bank (not shown) which then in turn powers said electric motors at each rotor location. The battery bank will also serve as boost power source when extra torque is needed during what is known in the art as “hot and high” hover and or flight operations, or other like situations that may require extra torque to be delivered to said system.

One embodiment of a control system (400) for use in embodiments of the invention is shown in FIG. 4a. A control component 412, which may comprise or include the CFP/SAS system, houses a number of components and has a number of inputs receiving information from parts of the aircraft systems. Sensors 402, for example monitoring drag on the wings or on the portions of the airframe housing the rotor system(s), provide one input. Information is also received from the thrust means, such as a thruster or prop 9 or 10, such as whether the thruster is currently operating, and the rate at which it is operating. The rotor system(s) 405 also provide input, such as their current pitch. These inputs are in this embodiment received and monitored by a monitoring module 406. This in turn communicates with a processor 408 of the control component, which provides the means for processing the information received along with stored instructions for management of the CFP/SAS, for example for responding with instructions to alter the pitch of a rotor system in response to a measurement of cruise speed received from either the thruster or the sensors.

The control component can be monitored, adjusted, calibrated or pre-programmed via a user/administrator/crew input 414. For example, instructions for a certain flight profile may be pre-configured, or a crew member may interact with the control system during flight.

Hover flight attitude of VTOL Aircraft 2 (FIG. 5) is controlled via conventional type physical pilot interface controls (not shown), i.e. typical hand yoke or centre stick controls for pitch and roll attitudes, rudder pedals for yaw axis control, and throttle and pitch control levers or knobs alike to control the thruster forces and or pitch settings. The collective, collective lifting rotor pitches, where the overall lift of the at least four total lifting rotors is controlled via one lever/knob. As a whole, the onboard flight control system is known as a “fly by wire” system, whereby inputs from the physical pilot controls as described above, are sensed by a main central flight processor (CFP) which is not shown, that in-turn drives the respective control surfaces, the various lift rotor and or propeller collective pitch mechanisms, and the engines all via servo motors specifically calibrated to actuate each. Further, within the CFP is an enhanced internal measurement unit coupled to a redundant sensor array that is altogether called the Stability Augmentation System (SAS). This comprehensive SAS (not shown) comprises of multiple (and redundant) gyroscopes, accelerometers, temperature, barometric, and as well as linear sensors that all work together between the pilot and the actual flight control surfaces, propellers, rotors, and engines to provide various intermediate control inputs in order to greatly reduce the pilot's work load, particularly during flight operations in more adverse conditions. The pilot has full authority of the control input, but as he or she holds said controls steady, the CFP/SAS takes care of the finite and maintaining control adjustments that keep the aircraft in the intended attitude and orientation during hover operations. This may be thought of or described as an autopilot function for hovering.

There are selectable flight modes and also the CFP/SAS has the ability to discern appropriate flight mode selection depending on aircraft speed, altitude, and orientation. During hover mode operations, when the pilot moves the control yoke or stick forward the aircraft moves forward and maintains a level pitch and roll axis attitude. When the pilot pulls back on the stick in hover mode, the aircraft moves rearward which again maintaining level pitch and roll axis attitudes. If the forward and indeed reversible thruster (109) is somehow disabled or inoperative, or further by specific pilot choice, an alternative hover control mode is automatically or selectively activated whereby the aircraft pitch and roll axis attitudes are effectively manipulated in order to manoeuvre the aircraft in hover. When the pilot moves the control yoke or stick forward in this alternate hover flight mode the collective pitch of the at least two rearward lift rotors (116, 118) is slightly increased while the collective pitch of the at least two forward lifting rotors (115, 115) is slightly and simultaneously decreased which acts upon the CG (49) of the aircraft to lower the nose and to enact differential forces that result in a forward aircraft motion. This is similar to a helicopter pilot cyclically tipping its main rotor forward with its respective control stick thereby causing its fuselage to nose down while moving the helicopter forward as well. When the pilot moves the control yoke or stick rearward in the aircraft in this alternate hover flight mode the collective pitch of the at least two rearward lift rotors (116, 118) is slightly decreased while the collective pitch of the at least two forward lifting rotors (115, 117) is slightly and simultaneously increased which acts upon the CG of the aircraft (49) to raise the nose and to enact differential forces that result in a rearward aircraft motion. It is to be noted as well, that in this alternative hover flight mode, a forward flight speed of at least one third of the aircraft's normal cruise velocity can be achieved by pitching the nose down as described just above and subsequently controlling the aircraft attitude via its normal aerodynamic surfaces. This is an effective backup and potential safety procedure that a pilot can employ should the main thrusters be disabled or somehow become inoperative.

Returning to aircraft attitude control during normal hover operations: When the pilot rotates the control yoke clockwise or moves the control stick to the right, the collective pitch of the at least two left side lifting rotors (115, 116) is slightly increased while the collective pitch of the at least two right side lifting rotors (117,118) is slightly and simultaneously decreased which acts upon the CG (49) and roll axis of the aircraft to lower the right wing (103) and raise the left side wing (102) enacting differential forces that result in the aircraft moving sideways toward the right. When the pilot rotates the control yoke counter-clockwise or moves the control stick to the left, the collective pitch of the at least two left side lifting rotors (115, 116) is slightly decreased while the collective pitch of the at least two right side lifting rotors (117, 118) is slightly and simultaneously increased which acts upon the CG (49) and roll axis of the aircraft to raise the right wing (103) and lower the left side wing (102) enacting differential forces that result in the aircraft moving sideways toward the left. To effect purposeful rotation or anti-rotation control about the aircraft's yaw axis the pilot will use the conventional rudder pedals at his feet. To turn or yaw the aircraft to the right, the pilot depresses the right pedal into the floor toward the front of the aircraft and the left pedal comes back toward the pilot given the usual expected push-pull bell-crank mechanism action that is employed in these systems. To turn or yaw the aircraft to the left, the pilot depresses the left pedal into the floor toward the front of the aircraft and the right pedal comes back toward the pilot given the usual expected push-pull bell-crank mechanism action that is employed in these systems. In hover modes the yaw attitude, or aircraft heading (compass direction), is maintained by the CFP/SAS by default. But the pilot can turn and point the aircraft at will, and once the rudder pedals are released again the CFP/SAS immediately maintains the new heading. One, or a combination of up to three methods are being employed to actually yaw the aircraft. Primarily, the yaw control comes from resultant aerodynamic force enacted by the thruster (109) air streams flowing over the rudder or rudevator control surfaces. Yawing commands to rotate the aircraft to the right are effected by reaction forces created from pivoting the rudder/rudevator control surfaces (123, 124) to the right and into the thruster flow streams thus creating the same nose right yaw force that the rudder/rudevator control surfaces (123, 124) create during forward flight while in relative wind flow streams. Yawing commands to rotate the aircraft to the left are effected by reaction forces created from pivoting the rudder/rudevator control surfaces (123, 124) to the left and into the thruster flow streams thus creating the same nose left yaw force that the rudder/rudevator control surfaces (123, 124) create during forward flight while in relative wind flow streams.

Secondarily, yaw control is effected and or enhanced by the CFP/SAS creating an unbalanced rotational torque force between opposite spinning rotor pairs; either by increasing collective pitch of opposite diagonally oriented rotor pairs (i.e. 115 & 118) and decreasing the collective pitch of the 90 degree axis relative pair (i.e. 117 & 116), or by simple increasing the RPM of said first pair and decreasing the RPM of the 90 degree axis relative pair alike. Thirdly, yaw control is enhanced by use of the ancillary nose mounted (131 in FIG. 3) or rear mounted (not shown) controllable rotor that is oriented to produce turning forces toward the sides of its mounted position. This force moment acts upon the CG of the aircraft (49) to cause a yaw rotation about its vertical axis, functioning much like a helicopter tail rotor does to counter the torque force of its main rotor and or sideways wind forces.

Further, the CFP/SAS actually maintains the position, heading, and altitude of the aircraft by default in the hover modes. The pilot can disengage this automatic attitude control manually if necessary or if desired. As part of an enhanced CFP/SAS feature, the aircraft has a plethora of forward and back, as well as side to side proximity sensors that serve to feed collision avoidance warnings and feedback to the pilot and the system itself. Once again, by default, the system will not allow the aircraft to come into contact with obstacles in its surroundings. This too, may be adjusted or even disabled if desired or necessary. Finally, the CFP/SAS system itself can (auto) pilot the aircraft completely autonomously. The system will be used in sub-scale versions of the aircraft designed to serve as unmanned aerial vehicles (UAVs), to be used for many mission sets that already exist, and to improve and even open many more types of applications offering unmatched controllability and safety to UAV operations.

Forward/Cruise flight attitude of VTOL Aircraft 2 (FIG. 5) is controlled via the same conventional type physical pilot interface controls (not shown), mentioned above. Again i.e. typical hand yoke or centre stick controls for pitch and roll attitudes, rudder pedals for yaw axis control, and throttle and pitch control levers or knobs alike to control the thruster forces and or pitch settings. Significantly different, once the pilot/CFP/SAS converts the aircraft to cruise flight mode, the lifting rotor collective pitches are reduced to a zero pitch blade angle setting so as to nearly eliminate the power draw on the overall drive train. At cruise flight speeds then the collective and or individual collective pitches of the lift rotors are automatically slightly adjusted by the CFP/SAS so as to move the aircraft's effective aerodynamic centre of lift by the resulting boundary layer air manipulation. This is enacted by said differential pressures in each rotor hole being created by the differing pitch settings (FIGS. 11 to 13). This wing shape morphing at cruise speeds subsequently allows or causes the aircraft to be trimmed to a more efficient drag profile thereby increasing range, speed, or capacity in a combination thereof. Once again, the pilot has full authority of the control inputs and the CFP/SAS system and can fly the aircraft manually, if desired. However, by default the CFP/SAS takes care of the finite rotor pitch adjustments that keep the aircraft in an optimized aerodynamic condition during cruise flight operations. This all in addition to the typical autopilot functions to maintain course heading and navigation parameters as well, or course. It should be noted as well that the CFP itself in addition to the SAS both have redundant processors and sensor arrays accordingly. This adds even more redundancy and safety to the overall aircraft operations.

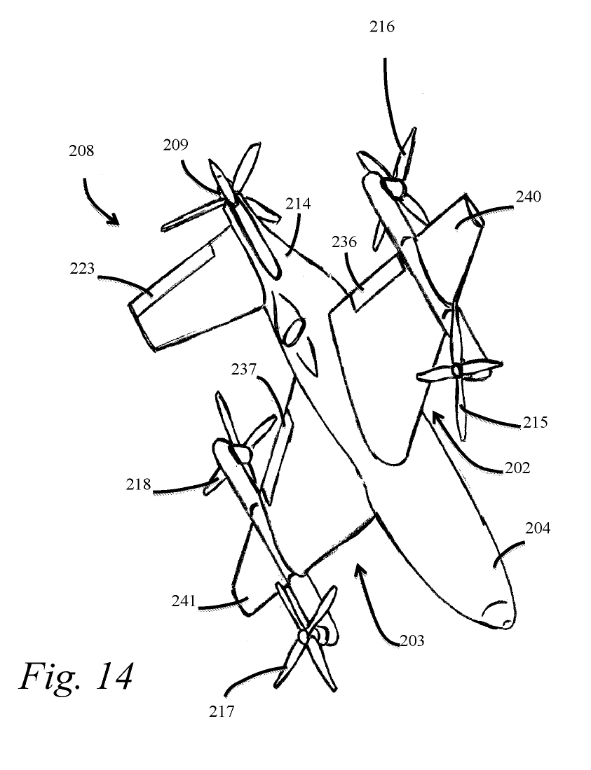

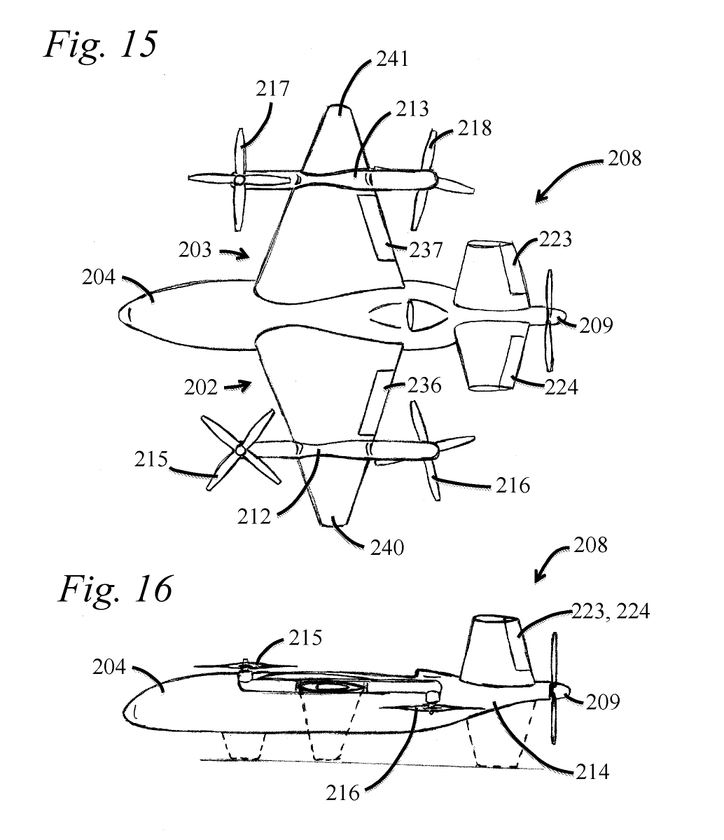

The VTOL Aircraft 3, referring to FIG. 14, is comprised of a main fuselage (204), a right (203) and left (202) main wing section, at least one forward thruster (209) aligned to the primary longitudinal axis, an optionally fore mounted horizontal stabilizer (not shown) and a V-Tail assembly (208). The left main wing (202) mounts onto the main fuselage (204) and or is extended from the left side of the main fuselage (204), and the right wing (203) as well, mounts onto the main fuselage (204) and or is extended from the right side of the main fuselage (204). The at least one forward thruster (209) is preferably mounted at the aft-most station position of the fuselage (204) behind the V-Tail assembly (208). Although preferably using dual-plane, contra-rotating propeller assemblies in order to mitigate single propeller torque affect, said thruster (209) may also employ an appropriate single propeller assembly, or utilize ducted exhaust from an axial jet engine, or a turbofan high-bypass type jet engine.

Mounted to the left main wing (202) at a station location at least 65% of the main wing span out from the centre of the aircraft is a left lift rotor beam frame (212), and mounted to the right main wing (203) at a station location at least 65% of the main wing span out from the centre of the aircraft is a right lift rotor beam frame (213). The left lift rotor beam frame (212) mounts and retains at least two preferably collective pitch lifting rotors assemblies, a forward lift rotor assembly (215) mounted above said beam frame and a rearward lift rotor assembly (216) mounted below said beam frame. The right lift rotor beam frame (213) also mounts and retains at least two preferably collective pitch lifting rotor assemblies, a forward lift rotor assembly (217) mounted above said beam frame and a rearward lift rotor assembly (218) mounted below said beam frame. Also attached and pivoting to/on the left main wing (202) at its wing span dimension is an articulating left wing extension (240), and attached and pivoting to/on the right main wing (203) at its wing span dimension is an articulating right wing extension (241). The V-Tail assembly (208) is mounted at an aft station location of the empennage (214) of the aircraft. An optional ancillary horizontal stabilizer is preferably mounted to the nose section of the fuselage (204) to provide additional pitch axis control authority, if necessary. Flight control surfaces are comprised of; an elevator or elevators that would be attached and pivot to/on the optional forward mounted horizontal stabilizer (206), and a rudevators (223, 224) are attached and pivot to/on the V-Tail assembly (208) accordingly, a left aileron (236) that is attached and pivots to/on the left main wing (202) at a more outboard station location, a right aileron (237) that is attached and pivots to/on the right main wing (203) at a more outboard station location, a left flap mechanism (not shown) that is attached and pivots to/on the left main wing (202) at a more inboard station location, and a right flap mechanism that is attached and pivots to/on the right main wing (203) at a more inboard station location.

Although said thruster (209) and lifting rotors (215, 216, 217, 218) could powered, and or driven, and rotate via a central transmission system similar to that previously described (50), and may utilize a combining gearbox (45) generally centrally mounted in the main fuselage (204), and which the engine or engines are mounted to as well, and then through subsequent drive shafting and ancillary gear boxes at or near each individual rotor assembly; it is much more preferred for this airframe configuration to use a hybrid fuel engine driven electric generation system may power specific electric drive motors located and likely alternatively mounting each respective rotor assembly that they are driving. The fuel engine will drive a generator that will in turn charge and maintain the power level of a main battery storage bank which then in turn powers said electric motors at each rotor location. The battery bank will also serve as boost power source when extra torque is needed during what is known in the art as “hot and high” hover and or flight operations, or other like situations that may require extra torque to be delivered to said system.

Hover flight attitude of VTOL Aircraft 3 (FIG. 14) is controlled via conventional type physical pilot interface controls (not shown), i.e. typical hand yoke or centre stick controls for pitch and roll attitudes, rudder pedals for yaw axis control, and throttle and pitch control levers or knobs alike to control the thruster forces and or pitch settings. The collective, collective lifting rotor pitches, where the overall lift of the at least four total lifting rotors is controlled via one lever/knob. As a whole, the onboard flight control system is known as a “fly by wire” system, whereby inputs from the physical pilot controls as described above, are sensed by a main central flight processor (CFP) which is not shown, that in-turn drives the respective control surfaces, the various lift rotor and or propeller collective pitch mechanisms, and the engines all via servo motors specifically calibrated to actuate each. Further, within the CFP is an enhanced internal measurement unit coupled to a redundant sensor array that is altogether called the Stability Augmentation System (SAS). This comprehensive SAS (not shown) comprises of multiple (and redundant) gyroscopes, accelerometers, temperature, barometric, and as well as linear sensors that all work together between the pilot and the actual flight control surfaces, propellers, rotors, and engines to provide various intermediate control inputs in order to greatly reduce the pilot's work load, particularly during flight operations in more adverse conditions. The pilot has full authority of the control input, but as he or she holds said controls steady, the CFP/SAS takes care of the finite and maintaining control adjustments that keep the aircraft in the intended attitude and orientation during hover operations. This may be thought of or described as an autopilot function for hovering.

There are selectable flight modes and also the CFP/SAS has the ability to discern appropriate flight mode selection depending on aircraft speed, altitude, and orientation. During hover mode operations, when the pilot moves the control yoke or stick forward the aircraft moves forward and maintains a level pitch and roll axis attitude. When the pilot pulls back on the stick in hover mode, the aircraft moves rearward which again maintaining level pitch and roll axis attitudes. If the forward and indeed reversible thruster (209) is somehow disabled or inoperative, or further by specific pilot choice, an alternative hover control mode is automatically or selectively activated whereby the aircraft pitch and roll axis attitudes are effectively manipulated in order to manoeuvre the aircraft in hover. When the pilot moves the control yoke or stick forward in this alternate hover flight mode the collective pitch of the at least two rearward lift rotors (216, 218) is slightly increased while the collective pitch of the at least two forward lifting rotors (215, 217) is slightly and simultaneously decreased which acts upon the CG (49) of the aircraft to lower the nose and to enact differential forces that result in a forward aircraft motion. This is similar to a helicopter pilot cyclically tipping its main rotor forward with its respective control stick thereby causing its fuselage to nose down while moving the helicopter forward as well. When the pilot moves the control yoke or stick rearward in the aircraft in this alternate hover flight mode the collective pitch of the at least two rearward lift rotors (216, 218) is slightly decreased while the collective pitch of the at least two forward lifting rotors (215, 217) is slightly and simultaneously increased which acts upon the CG (49) of the aircraft to raise the nose and to enact differential forces that result in a rearward aircraft motion. It is to be noted as well, that in this alternative hover flight mode, a forward flight speed of at least one third of the aircraft's normal cruise velocity can be achieved by pitching the nose down as described just above and subsequently controlling the aircraft attitude via its normal aerodynamic surfaces. This is an effective backup and potential safety procedure that a pilot can employ should the main thrusters be disabled or somehow become inoperative.

Returning to aircraft attitude control during normal hover operations: When the pilot rotates the control yoke clockwise or moves the control stick to the right, the collective pitch of the at least two left side lifting rotors (215, 216) is slightly increased while the collective pitch of the at least two right side lifting rotors (217,218) is slightly and simultaneously decreased which acts upon the CG (49) and roll axis of the aircraft to lower the right wing (203) and raise the left side wing (202) enacting differential forces that result in the aircraft moving sideways toward the right. When the pilot rotates the control yoke counter-clockwise or moves the control stick to the left, the collective pitch of the at least two left side lifting rotors (215, 216) is slightly decreased while the collective pitch of the at least two right side lifting rotors (217, 218) is slightly and simultaneously increased which acts upon the CG (49) and roll axis of the aircraft to raise the right wing (203) and lower the left side wing (202) enacting differential forces that result in the aircraft moving sideways toward the left. To effect purposeful rotation or anti-rotation control about the aircraft's yaw axis the pilot will use the conventional rudder pedals at his feet. To turn or yaw the aircraft to the right, the pilot depresses the right pedal into the floor toward the front of the aircraft and the left pedal comes back toward the pilot given the usual expected push-pull bell-crank mechanism action that is employed in these systems. To turn or yaw the aircraft to the left, the pilot depresses the left pedal into the floor toward the front of the aircraft and the right pedal comes back toward the pilot given the usual expected push-pull bell-crank mechanism action that is employed in these systems. In hover modes the yaw attitude, or aircraft heading (compass direction), is maintained by the CFP/SAS by default. But the pilot can turn and point the aircraft at will, and once the rudder pedals are released again the CFP/SAS immediately maintains the new heading. One or a combination of up to three methods are being employed to actually yaw the aircraft. Primarily, yaw control is effected and or enhanced by the CFP/SAS creating an unbalanced rotational torque force between opposite spinning rotor pairs; either by increasing collective pitch of opposite diagonally oriented rotor pairs (i.e. 215 & 218) and decreasing the collective pitch of the 90 degree axis relative pair (i.e. 217 & 216), or by simple increasing the RPM of said first pair and decreasing the RPM of the 90 degree axis relative pair alike. Yaw axis control is also enhanced by use of the ancillary nose/gear mounted (131) or rear lower ventral fin mounted controllable rotor (not shown) both of which are oriented to produce turning forces toward the sides of its mounted position. This force moment acts upon the CG of the aircraft to cause a yaw rotation about its vertical axis, functioning much like a helicopter tail rotor does to counter the torque force of its main rotor and or sideways wind forces.

Further, the CFP/SAS actually maintains the position, heading, and altitude of the aircraft by default in the hover modes. The pilot can disengage this automatic attitude control manually if necessary or if desired. As part of an enhanced CFP/SAS feature, the aircraft has a plethora of forward and back, as well as side to side proximity sensors that serve to feed collision avoidance warnings and feedback to the pilot and the system itself. Once again, by default, the system will not allow the aircraft to come into contact with obstacles in its surroundings. This too, may be adjusted or even disabled if desired or necessary. Finally, the CFP/SAS system itself can (auto) pilot the aircraft completely autonomously. The system will be used in sub-scale versions of the aircraft designed to serve as unmanned aerial vehicles (UAVs), to be used for many mission sets that already exist, and to improve and even open many more types of applications offering unmatched controllability and safety to UAV operations.

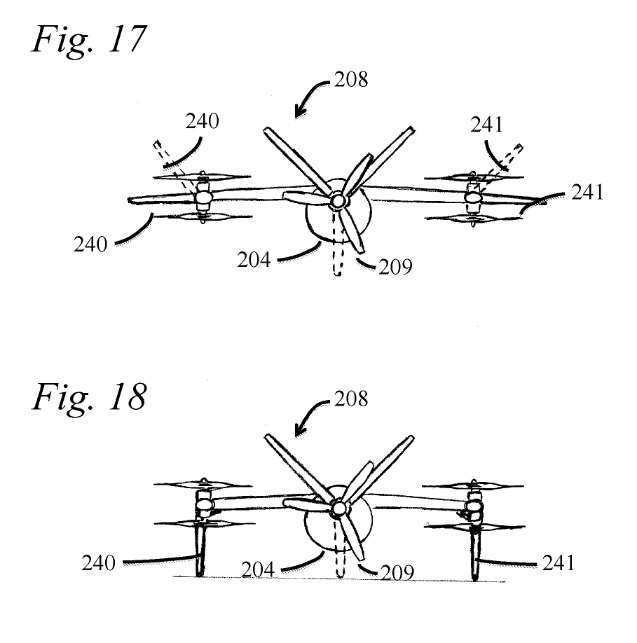

Forward/Cruise flight attitude of VTOL Aircraft 3 (FIG. 14) is controlled via the same conventional type physical pilot interface controls (not shown), mentioned above. Again i.e. typical hand yoke or centre stick controls for pitch and roll attitudes, rudder pedals for yaw axis control, and throttle and pitch control levers or knobs alike to control the thruster forces and or pitch settings. Significantly different, once the pilot/CFP/SAS converts the aircraft to cruise flight mode, the lifting rotor collective pitches are reduced to a zero pitch blade angle setting so as to nearly eliminate the power draw on the overall drive train. If fixed-pitch rotors are in place the CFP/SAS stops them and they are physically aligned with the lift rotor beam frame they are mounted to, or they may employ an augmented pivoting blade mount that allows each blade to sweep back into a less obtrusive position in order to minimize their otherwise extra frontal drag profile. The CFP/SAS also controls the movements and positions if the left articulating wing extension (240), and the right articulating wing extension (241) as well. During hover flight these wing extensions are in a lowered position perpendicular to the main wing spar/span line as shown in FIG. 18, and they remain in this vertical orientation during climb as well to minimize plate/face aerodynamic resistance. During cruise flight the CFP/SAS rotates these extensions (240, 241) to be at least parallel with the main wings (202, 203), but also can rotate them upward to an optimized position to effectively act as winglets during highest speed cruise flight as shown in FIG. 17. They are adjusted according to forward velocity and flight conditions alike to best optimize the aircraft's slip stream by reducing wing tip vortices as effectively as possible. These pilot assisting and aircraft optimizing functions are all in addition to the typical autopilot functions to maintain course heading and navigation parameters as well, or course. It should be noted as well that the CFP itself in addition to the SAS both have redundant processors and sensor arrays accordingly. This adds even more redundancy and safety to the overall aircraft operations.

It will be appreciated by those skilled in the art that the invention has been described by way of example only, and that a variety of alternative approaches may be adopted without departing from the scope of the invention, as defined by the appended claims.

1. A vertical take-off and landing aircraft, having a vertical motion mode and a forward thrust mode, the aircraft comprising:
an airframe, comprising a wing section;
a forward thrust means, for use during the forward thrust mode;
a vertical lift rotor system, the rotor system being housed in a portion of the airframe; and
a rotor control component configured to, during forward thrust, actuate the rotor system to modify the aerodynamic flow around the portion of the airframe housing the rotor system.

2. An aircraft according to claim 1, wherein the rotor control component is configured to alter the pitch of one or more rotor blades of the rotor system.

3. An aircraft according to claim 1 or claim 2, wherein the rotor control component is configured to activate rotation of the rotor system.

4. An aircraft according to any preceding claim, further comprising a plurality of sensors, which sensors operable to provide input to the rotor control component for modification of the aerodynamic flow.

5. An aircraft according to claim 4, wherein the control component comprises one or more inputs for receiving information from: the sensors; the rotor system; and the thrust means.

6. An aircraft according to any preceding claim, wherein the airframe comprises a plurality of aerodynamic manipulation devices for additional modification of the aerodynamic flow.

7. An aircraft according to any preceding claim, wherein said portion of the airframe housing the rotor system comprises an aerofoil.

8. An aircraft according to claim 7, wherein the wing section comprises said portion.

9. An aircraft according to any preceding claim, wherein at least one vertical lift rotor of the rotor system is housed in a ducted tunnel within said portion of the airframe.

10. An aircraft according to any preceding claim, wherein the rotor system comprises a plurality of vertical lift rotors.

11. An aircraft according to any preceding claim, wherein a proportion of the airframe in comparison to a diameter of the rotor system is configured such that a disk loading of the rotor system is in excess of 27 pounds per square foot.

12. An aircraft according to claim 11, wherein the disk loading is in excess of 100 pounds per square foot.

13. An aircraft according to any preceding claim, wherein, the rotor control component is configured to, on the aircraft entering the forward thrust mode, reduce a blade pitch of the rotor system to zero.

14. An aircraft according to any preceding claim, wherein the rotor control component is in addition configured to drive the rotor system to produce movement of the aircraft in directions away from a vertical lift axis.

15. A control method for a vertical take-off and landing aircraft, the aircraft having a vertical motion mode and a forward thrust mode, the aircraft comprising: an airframe, comprising a wing section; a forward thrust means, for use during the forward thrust mode; and a vertical lift rotor system, the rotor system being housed in a portion of the airframe, the method comprising:
during the forward thrust mode, actuating the rotor system to modify the aerodynamic flow around the portion of the airframe housing the rotor system.

16. A vertical take-off and landing aircraft comprising:
a main fuselage section;
a left main wing extending from a left side of said fuselage and a right main wing extending from a right side of said fuselage;
a lifting rotor that is shrouded within said left wing with its centre at a station location of less than 45 percent of the wing span dimension, and at least a second lift rotor shrouded within said left wing behind or slightly off-parallel line to the first rotor in relation to an overall longitudinal axis of the aircraft;
a lifting rotor that is shrouded within said right wing with its centre at a station location of less than 45 percent of the wing span dimension, and at least a second lift rotor shrouded within said right wing behind or slightly off-parallel line to the first rotor in relation to the overall longitudinal axis of the aircraft; and
at least two longitudinally aligned primary forward thrusters.

17. The aircraft of claim 16, further comprising:
a vertical stabilizer that extends from and/or is co-mounted with a rear horizontal stabilizer, or is mounted independently extending from a rearward section of the main and/or an ancillary fuselage, or near the rearmost section of an empennage.

18. The aircraft of claim 17, further comprising:
a horizontal stabilizer at the rear and/or the front of said aircraft, to provide additional pitch axis control authority.

19. The aircraft of claim 18, wherein a main horizontal stabilizer is mounted near or on the upper section of said rearward mounted vertical stabilizer.

20. The aircraft of any of the claims 16 to 19, further comprising a rotor control component.

21. The aircraft of claim 20, wherein the rotor control component is configured to provide like directional rotation of opposite pairs of said lifting rotors, with positioning of said pairs of lifting rotors rotation-matching in orientation to be diagonally opposite, or left side to right side opposite rotations, or front to back relative positions of opposite rotation, in dependence on an overall aircraft configuration and the total number of rotors.

22. The aircraft of any of the claims 16 to 21, further comprising:
a controllable nose rotor mounted and contained within the nose section of said fuselage.

23. The aircraft of claim 22, wherein the nose rotor is co-mounted and retractable in concert with the aircraft main nose-positioned landing gear assembly.

24. The aircraft of any of the claims 16 to 21, further comprising a controllable rear mounted rotor, the rotor either contained in or located and co-mounted with the vertical stabilizer.

25. The aircraft of any of the claims 16 to 21, further comprising a vertically oriented ventral fin structure below the rearward main fuselage or empennage.

26. The aircraft of any of the claims 20 to 25, wherein the rotor control component is configured to collectively and/or individually control a collective blade pitch pf the respective rotors, via a central flight processor (CFP) and stability augmentation system (SAS).

27. The aircraft of claim 26, wherein the rotor control component and/or the CFP/SAS is further configured to convert the aircraft between normal forward flight and vertical landing flight modes.

28. The aircraft of claim 27, wherein the rotor control component is further configured to modify the effective boundary layer air streams flowing around the lift rotor wing housings.

29. A vertical take-off and landing aircraft having a substantially thick-chorded, blended and tapered main wing design, the aircraft comprising:
a main fuselage section that is abbreviated near a main wings' trailing edge dimension;
a main wing mounted on and extending from the left side of said fuselage, and from the right side of said fuselage;
a left side tail boom empennage mounted to and extending rearward from the left main wing at a station location of at least 45 percent of the wing span dimension;
a right side tail boom empennage mounted to and extending rearward from the right main wing at a station location of at least 45 percent of the wing span;
a primary forward lift rotor embedded in said left main wing section with its centre located at a span station of 45 percent of the wing's span dimension from the centre of the main fuselage, and at least one other rotor embedded in said left wing section generally behind said primary forward lift rotor's mount,
a primary forward lift rotor embedded in said right main wing section with its centre located at a span station of 45 percent of the wing's span dimension from the centre of the main fuselage, and at least one other rotor embedded in said right wing section generally behind said primary forward lift rotor's mount;
wherein said at least two left side lifting rotors and said at least two right side lifting rotors are each configured to provide collective pitch control; and
at least one primary forward thruster generally aligned with the primary longitudinal axis of said aircraft.

30. The aircraft of claim 29, further comprising:
a horizontal stabilizer at the rear and/or the front of said aircraft, to provide pitch axis control authority.

31. The aircraft of claim 30, further comprising:
a vertical stabilizer that extends from, and may be co-mounted with the rear horizontal stabilizer, to said tail boom empennages, and/or is mounted independently from the front horizontal stabilizer, and is mounted and extends from a rearward station location of the left and right empennages.

32. The aircraft of claim 31, wherein the aircraft, with reference to said vertical stabilizer mounted to said tail boom empennages, is configured to align the majority of the centred profile area between said empennages with the thrust flow of the thruster mounted in front of control surfaces at the rear of the abbreviated main fuselage.

33. The aircraft of any of the claims 29 to 32, further comprising a rotor control component.

34. The aircraft of claim 33, wherein the rotor control component is configured to provide directional rotation of at least pairs of lifting rotors in the overall system, with positioning of said pairs of lifting rotors rotation-matching orientation to be diagonally opposite, or left side to right side opposite rotations, or front to back relative positions of opposite rotation, dependent on overall aircraft configuration and a total number of rotors.

35. The aircraft of any of the claims 29 to 34, further comprising:
a controllable rotor mounted and contained within the main fuselage, in fixed position such that its resulting thrust force is operable upon the yaw axis of the aircraft;
or optionally co-mounted and moving in concert with the aircraft main nose-positioned landing gear assembly.

36. The aircraft of claim 33, claim 34 or claim 35, wherein the rotor control component is configured to individually control each rotor's collective blade pitch.

37. The aircraft of claims 29 to 36, further comprising:
a central flight processor for augmenting the control and stability of the aircraft during hovering operations, and through the transitional flight modes between hover operations and forward, wing-born flight operations as well.

38. A vertical take-off and landing aircraft, comprising:
a main fuselage section;
a left main wing mounted on and extending from the left side of said fuselage and a right main wing mounted on and extending from the right side of said fuselage;
a left, sub-fuselage, lift rotor beam frame mounted on said left wing at a station location of at least 65 percent of the wing span dimension;
a right, sub-fuselage, lift rotor beam frame mounted on said right wing at a station location of at least 65 percent of the wing span dimension;
a left lifting rotor mounted forward on and above said left mounting beam frame;
and at least a second left lifting rotor mounted rearward on but below said left mounting beam frame;
a right lifting rotor mounted forward on and above said right mounting beam frame; and at least a second right lifting rotor mounted rearward on but below said right mounting beam frame;
at least two left lift rotor systems and at least two right lift rotor systems, each having collective pitch control;
at least one primary forward thruster generally aligned with the primary longitudinal axis of said aircraft and mounted aft of the empennage section.

39. The aircraft of claim 38, further comprising:
an ancillary horizontal stabilizer at the front of said aircraft in to provide pitch axis control authority.

40. The aircraft of claim 38 or claim 39, further comprising:
a V-Tail horizontal/vertical stabilizer mounted to and extending upward from the rear of an empennage section of the main fuselage.

41. The aircraft of any of the claims 38 to 40, further comprising a rotor control component.

42. The aircraft of claim 41, wherein the rotor control component is configured to provide like directional rotation of at least pairs of lifting rotors, with positioning of said pairs of lifting rotors rotation-matching in orientation to be diagonally opposite, or left side to right side opposite rotations, or front to back relative positions of opposite rotation, in dependence on aircraft configuration a total number of rotors.

43. The aircraft of any of the claims 40 to 42, further comprising a controllable rotor mounted and contained within the main fuselage, in fixed position such that its resulting thrust force acts upon the yaw axis of the overall aircraft;
or optionally co-mounted and moving in concert with the aircraft main nose-positioned landing gear assembly;
or alternatively wherein said controllable rotor is mounted in an additional vertically oriented lower ventral fin structure below the V-Tail assembly at the rear of the empennage.

44. The aircraft of any of the claims 41 to 43, wherein the rotor control component is configured to individually control each rotor's collective blade pitch.

45. The aircraft of any of the claims 38 to 44, further comprising:
a central flight computer configured to augment the control and stability of the aircraft during hovering operations, and through the transitional flight modes between hover operations and forward, wing-born flight operations as well.

46. The aircraft of any of the claims 1 to 14 and 16 to 45, the wing or wing section comprising at least one articulated wing extension.

47. A computer program application or a computer readable medium comprising computer program code adapted, when loaded into or run on a computer or processor, to cause the computer or processor to carry out a method, according to claim 15.
